(19) United States
(12) Patent Application Publication
(10) Pub. No.: US 2008/0287844 A1
(43) Pub. Date: Nov. 20, 2008

(54) Hydromassage Apparatus

(76) Inventor: Manuel Sanchez Soriano, Sant Quirze del Valles (ES)

Correspondence Address: KED & ASSOCIATES, LLP, P.O. Box 221200, Chantilly, VA, 20153-1200, US

(21) Appl. No.: 11/663,653

(22) PCT Filed: Sep. 21, 2005
(86) PCT No.: PCT/IB05/02797

§ 371 Date: Jun. 30, 2008

(30) Foreign Application Priority Data
Sep. 24, 2004 (EP) 04380191.9

(51) Int. Cl. A61H 9/00

(52) U.S. Cl. 601/154

(57) ABSTRACT

Body treatment apparatus via hydromassage. It comprises a flattened base (3) for the rest and support of the user, and an articulated covering body (4) with opening and closing means that, with the flattened base (3), define a housing for the positioning of the user in its interior during the treatment, a footing (1) on the ground and a support frame (2) that is characterized in that in the inner part of the body of the apparatus includes a hitting device constituted by a plurality of liquid sprinkler mechanisms (11), placed in at least two horizontal and parallel flatbars (9, 10) or with a certain degree parallelism, equipped with alternative movements in opposite directions one in respect to the other and driven by means of devices (24 to 27) with speed regulation and moving stroke regulation.

Body treatment apparatus via hydromassage, specially for the concrete application of showers and massages by means of jets of shower water, that comprises a flattened base for the rest and support of the user, and an articulated covering body with opening and closing means that, with the flattened base, define a housing for the positioning of the user in its interior during the treatment, a footing on the floor and a support frame characterized in that in the inner part of the body of the apparatus includes a hitting device constituted by a plurality of liquid sprinkler mechanisms, placed in at least two horizontal and parallel flatbars or with a certain degree parallelism, equipped with alternative movements in opposite directions one in respect to the other and driven by means of devices with speed regulation and moving stroke regulation.

### BACKGROUNDS OF THE INVENTION

In the state of the art there are devices for caring diverse parts of the body by means of hydrojet with application under control, looking for the beneficial effect of the shower under determined pressure and temperature by means of hydrojet with the appropriate flow.

The well known apparatus of this class have restrictions derived from the little versatility of the hydrojet generating devices, which reduces the possibilities of effectiveness of the treatments, and also the practical conditions of the use of the apparatus for the users are limited.

In this way, it is known the Spanish Patent n^{o} 9100939 (ES2047404) in the name of the firm SYBARITIC, INC., of the year 1991, that refers to a personalized sauna comprising an elongated, horizontally extending bed which is connected to a supporting pedestal. The bed is positioned at least partially within the pedestal and is designed to an individual in a horizontal position. The sauna also includes a structure for uniformly directing downwardly heated, recirculating air above and over the top of the bed to provide an air shower and a flow of air over a person lying on the bed. The structure includes a cover member, hingedly mounted to the pedestal at the end which extends substantially along the entire length of the bed. An elongated upper chamber is formed within the cover member and extends substantially along the entire length of the cover member. A duct is formed on the cover and has air outlet openings leading from the duct to the chamber for introducing recirculated air into the chamber. A blower is supported on the cover for circulating air from the chamber, which enters through air inlet openings, into the duct. A heating element is provided within the duct for heating the air. The air outlets are spaced substantially along the entire length of the duct and upper chamber for downwardly distributing air heated by the elements from the duct into the chamber and thus, above and over the individual's body lying atop the bed with a generally uniform air flow rate along the length of the body

Also it is known the Japanese Patent n^{o} 6023009 that describes an apparatus for hydromassage which purpose is to achieve a handy support structure of a rotary cover while enabling the hitting of shower water to a desired part of a person taking a bath by changing the direction of jetting the shower water in a shower bath apparatus. The rotary cover is mounted on a beam member provided on a receiving tank free to turn and upper nozzles of an upper shower provided along the beam member is made free to turn so that shower water can be jet in a direction covering the head to feet of a person taking a bath.

### BRIEF DESCRIPTION OF THE PATENT

The present invention refers to a body treatment apparatus via hydromassage.

The field of the invention is the one of the apparatuses designed to the care of the human body by means of specific treatments, such as the focused application of manual and hydraulic massages, radiations and diverse products. In the present case, the invention contemplates the application of hydrojet under controlled pressure, temperature and flow to diverse corporal parts.

Taking into account the backgrounds previously indicated it became necessary, then, to have an apparatus that allowed obtaining the maximum yield of the treatments with water under predetermined pressure and volume on the human body, and simultaneously that provided to its users a use comfort during the use sessions.

The apparatus that will be described avoids the mentioned disadvantages and provides a hydromassage system of high effectiveness. Specially, the hydrojets can be managed to the selected corporal parts under the best functional conditions and with total directivity, thanks to a rational accomplishment of the jets.

On the other hand, the users, during the treatments, take benefit from an ergonomic design of the apparatus, which provides a great comfort to them during its stay in the inner part of the same one.

It is an object of the present invention a body treatment apparatus via hydromassage, specially for the concrete application of showers and massages by means of jets of shower water, that comprises a flattened base for the rest and support of the user, and an articulated covering body with opening and closing means that, with the flattened base, define a housing for the positioning of the user in its interior during the treatment, a footing on the ground and a support frame characterized in that in the inner part of the body of the apparatus includes a hitting device constituted by a plurality of liquid sprinkler mechanisms, placed in at least two horizontal and parallel flatbars or with a certain degree parallelism, equipped with alternative movements in opposite directions one in respect to the other and driven by means of devices with speed regulation and moving stroke regulation.

It is an additional object of the present invention that each one of the sprinkler mechanisms includes an axial tubular rod with an extreme mouth of water entrance and an exit orifice in its other end, as well as a pair of spherical protuberances with corresponding individual cylindrical elements associated, equipped with flanges and annular elements defining a pair of ball joints in opposition, ready to be coupled to the flatbars, respectively.

It is another additional object of the present invention that the footing includes a carrier horizontal frame for a plurality of telescopic struts which form the support frame and bringer of the flattened base, defined by a peripheral frame that, in one of its ends, has an articulated arm for the up and under of the covering body.

With the purpose to facilitate the explanation sheets of drawings are attached to the present description, in which a practical case of an embodiment has been reproduced, which is mentioned only for exemplificative, non limitative of the scope of the present invention a body treatment apparatus via hydromassage, according to the principles of the claims.

### BRIEF DESCRIPTION OF THE DRAWINGS

FIG. 1 is a general view and in perspective of the frame of the new apparatus, and

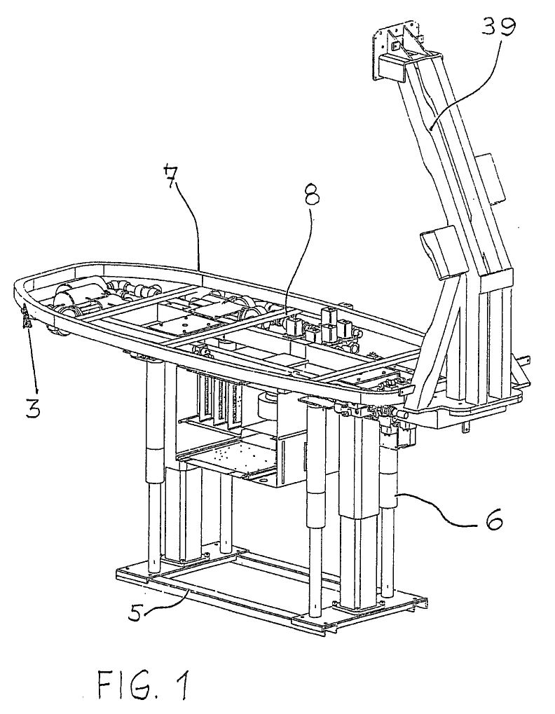

FIG. 2 is an extended view of the inferior part of the same one.

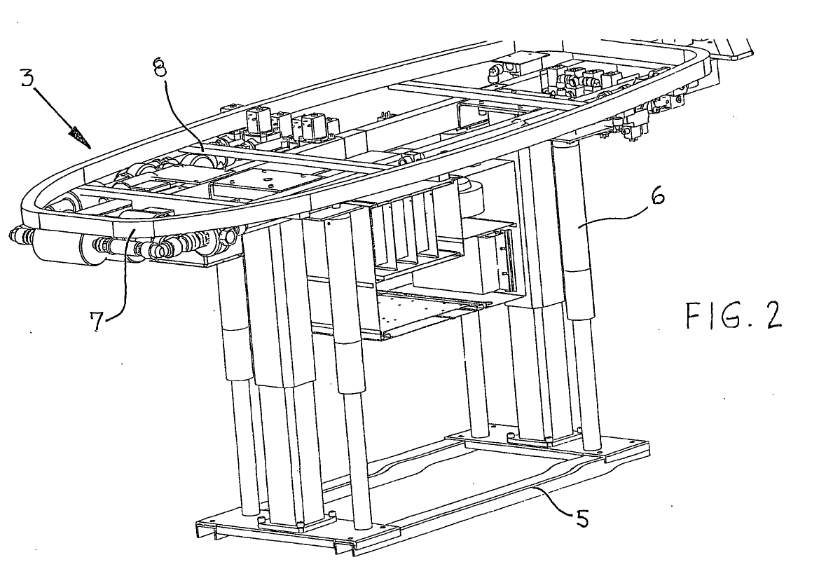

FIG. 3 is a general view of the end zone of the multiple controlled jets for the hydromassage,

FIG. 4 shows a perspective view of one of the hitting elements and

FIG. 5 is a sectioned view of the mentioned element.

FIG. 6 represents the carrying and activator device of the hitting 1D elements.

FIGS. 7 and

8 show the previous device with its activator and regulation elements, in a lateral and perspective view, respectively.

FIG. 9 represents, in a general view, the new apparatus during its use by a user, and

FIG. 10 illustrates a section cut for line II-II of FIG. 9, a protective element for the user's head.

### PREFERRED EMBODIMENT OF THE PRESENT INVENTION

The elements designated with numbers in the drawings correspond to the indicated parts as follows.

The apparatus for corporal treatments that is described comprises a footing 1, a support frame 2 and a base 3 for supporting the user's body during the hydromassage sessions. Over the flattened base 3 there is an articulated covering body 4 that defines a housing, occupied by the user and who avoids the exit of water to the outside.

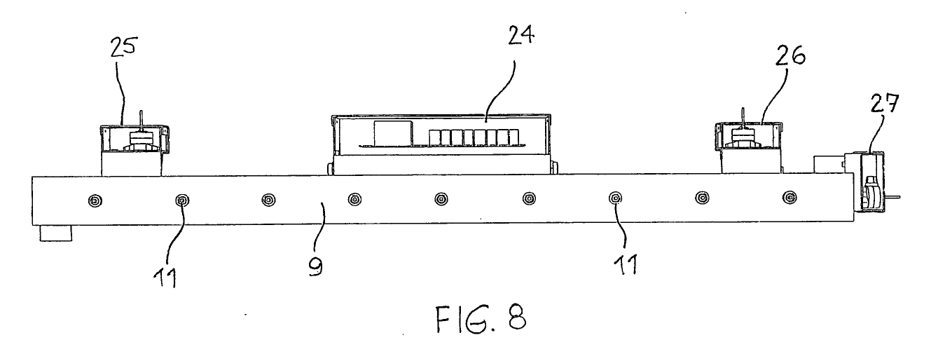

The user is placed horizontally in the inner part of the apparatus and the user is under the action of the hydrojets dully controlled, preferably they are managed to the user's body and the user's extremities, excluding the head, as it is seen in FIG. 9.

The base 1 advantageously comprises a carrier frame 5, and the support frame 2 is constituted by a plurality of telescopic struts 6 that allow to regulate the height of base 3 in respect to the floor, with the purpose of facilitating the access and the exit of the users from and to said base 3.

On the other hand, the flattened base 3 consists of a frame 7 defined by its perimeter and a series of reinforcement cross members 8.

Covering body 4 is kept by an articulated arm 39 in one of the ends of frame 7, allowing in its high position the entrance and the exit of the user from and to the inner part of the apparatus.

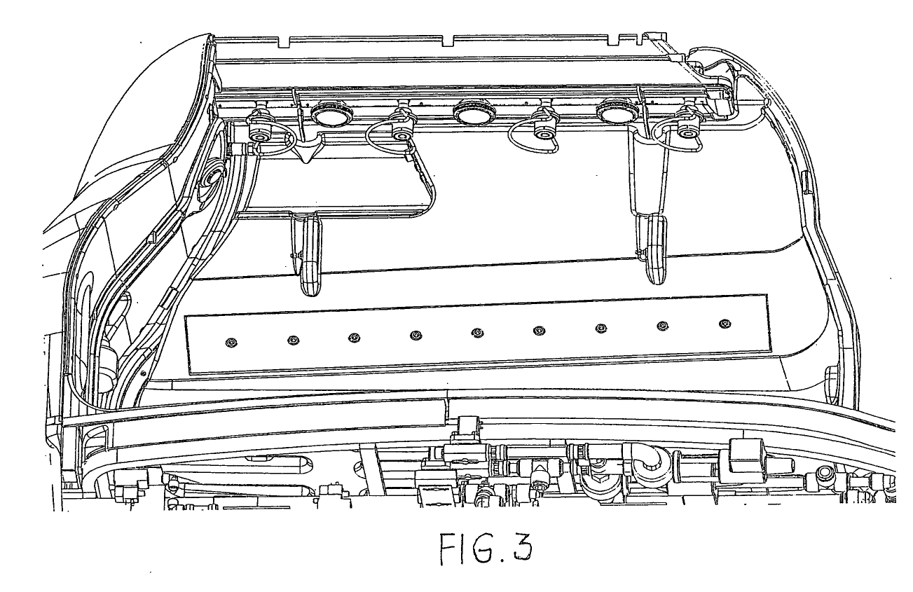

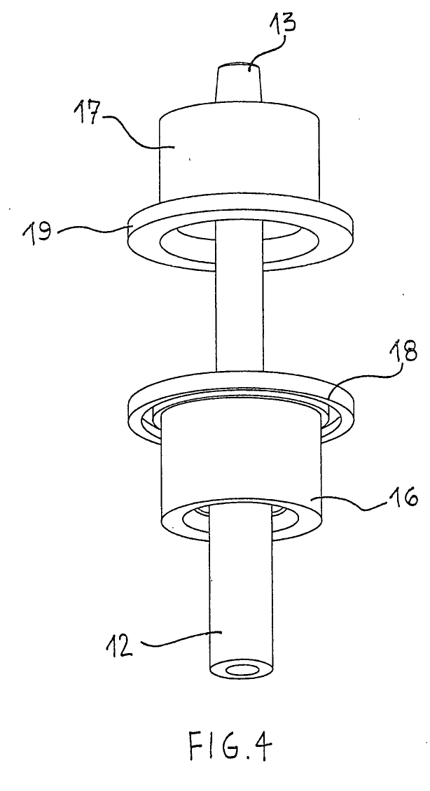

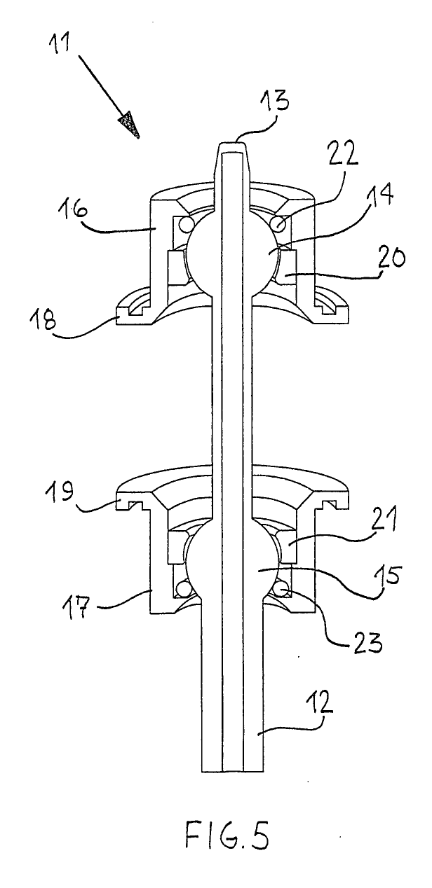

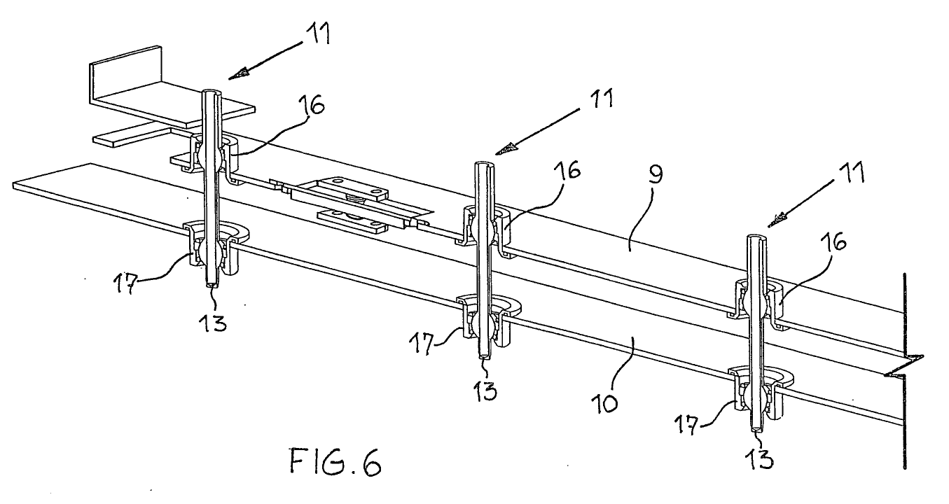

FIG. 3 is a view of the inner part of the apparatus in which it appears a characteristic part of the same one, constituted by the jetwater and separately represented in FIG. 6. Essentially comprises parallel flatbars 9, 10, rectangular extended and parallels or with a certain degree of parallelism, basing between them a plurality of sprinkler mechanisms 11, represented individually in FIGS. 4 and 5.

Each one of the mechanisms 11 comprises a tubular axial rod 12 joint by an end 12 to a water entrance pipe and equipped in its other end of a small orifice 13 for the exit of the water. Laterally, the rod 12 has a pair of spherical protuberances 14 and 15 of equal diameters, around which they appear the cylindrical pieces 16 and 17, equipped with the respective flanges 18 and 19.

Elements 16 and 17 are coupled in opposed positions to rod 12 and they are associated to the same through the rings 20 and 21, of tapered section with a concave side, thus defining each cylindrical piece with the rod an elementary ball joint mechanism. O-ring seals 22 and 23 assure the watertightness ball joints with respect to the respective ends of the pieces 16 and 17.

The mechanisms of double ball joint that have been described are mounted between the flatbars 9 and 10, according to the FIG. 6, in such a way that each one of these incorporates a superior or inferior ball joint set in opposition.

Flatbars 9 and 10 carry out alternative movements, remaining always parallelly to themselves and one to another one or with a certain degree of parallelism. These movements are obtained by means of mechanisms of the state of the art, such as pinion and rack, sets of chain and/or pulley and similars, of adjustable stroke, actuated by means of an electric motor with reducer and associated to switches at the end of the stroke, conventional components not described nor claimed here.

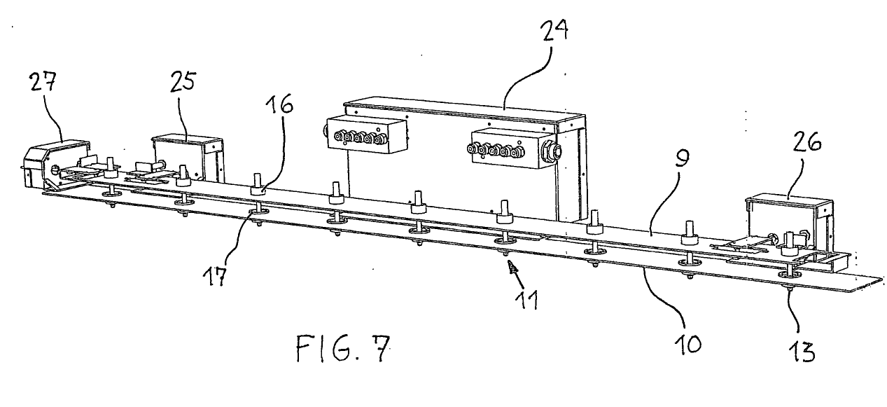

In FIGS. 7 and 8 the box 24 houses the activator device of the flatbars 9 and 10, the boxes 25, 26 and 27 contain elements for the stroke and the speed control of the mutual movement of said flatbars.

The double ball joints constituted by the mechanisms 11 and movements of their rods 12 determined by the alternative movements of the flatbars 9 and 10 confer to the jetwater device of the apparatus an extraordinary versatility that is translated in a high effectiveness in its function.

As it has been previously indicated, the user of the apparatus of the invention normally keeps the head outside of the body 4, according to FIG. 9, emerging by an opening at the end of the mentioned body. A laminar, flexible and watertightness element 28 is used, made of fabric, plastic or polymers, with a superficial treatment, that, as a drop curtain or curtain, allows the passage of the head, that keeps isolated and resting on a pillow.

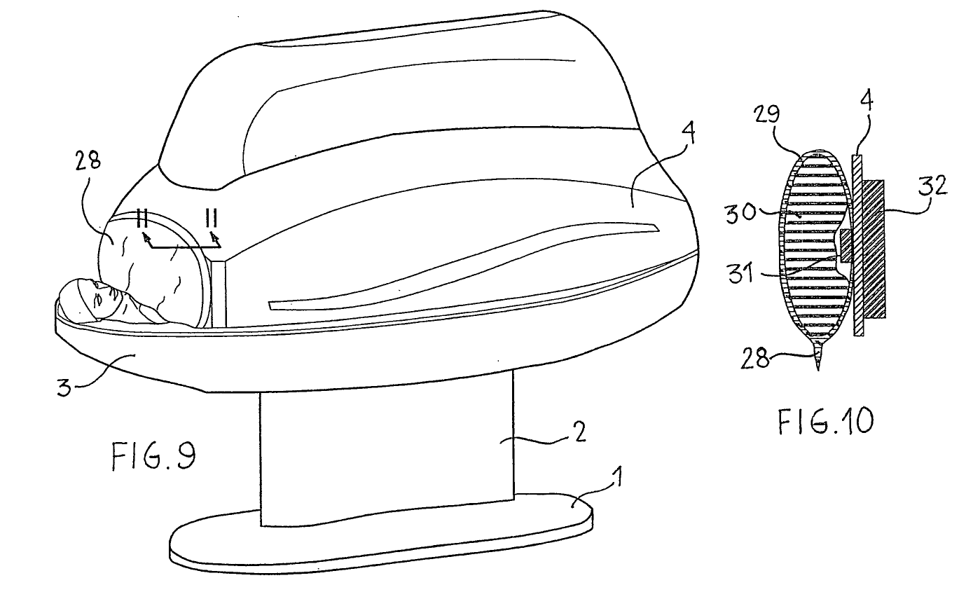

FIG. 10 shows a possible way to couple the drop curtain 28 to the body 4 of the apparatus, by means of a peripheral support 29 occupied by a filling 30 and a permanent magnet 31, this one next to its external wall. In the internal face of the body 4 there is at least a second permanent magnet 32. Going closer the peripheral support 29 to the body 4, in such a way that magnets 31 and 32 are next and separated by the respective walls, the attraction between those ones assures the temporary retention of the support 29, and therefore the one of the drop curtain 28, against the body 4, whose inner part is thus isolated. Diverse pairs of magnets 31 and 32 will be advantageously placed.

The present patent describes a new body treatment apparatus via hydromassage. The examples mentioned here are not limitative of the present invention, for that reason it will be able to have different applications and/or be adapted, all of them within the scope of the following claims.

1-6. (canceled)

7. A body treatment apparatus via hydromassage, specially for the local application of showers and massages by means of jets of shower water, comprising:
a flattened base for the rest and support of the user; and
an articulated covering body provided with opening and closing means that, with the flattened base, define a housing for the positioning of the user in its interior during the treatment;
a footing on the ground; and
a support frame, characterized in that in the housing defined by the flattened base and the articulated covering body of the apparatus includes a hitting device constituted by a plurality of liquid sprinkler mechanisms, placed in at least two horizontal and parallel flatbars, capable of carrying out alternative movements in opposite directions one in respect to the other and driven by means of devices with speed regulation and moving stroke regulation and in that each one of the sprinkler mechanisms includes an axial tubular rod with an extreme mouth of water entrance and an exit orifice in its other end, as well as a pair of spherical protuberances with corresponding individual cylindrical elements associated, equipped with flanges and annular elements defining a pair of ball joints in opposition, ready to be coupled to the flatbars, respectively.

8. The apparatus, according to claim 7, characterized in that the length of the covering body corresponds to the length of the user's body, with exclusion of user's head, that appears through an extreme opening with a temporary closing element as flexible drop curtain.

9. The apparatus according to claim 8, characterized in that the temporary closing element has separable means for coupling it to the covering body, constituted by permanent magnets associated respectively to a peripheral support of the closing element and in the periphery of the covering body opening.

10. The apparatus, according to claim 7, characterized in that the footing includes a carrier horizontal frame for a plurality of telescopic struts which form the support frame and bringer of the flattened base, defined by a peripheral frame that, in one of its ends, has an articulated arm for the up and under of the covering body.

11. The apparatus, according to claim 10, characterized in that the support frame is adjustable height.
